(19) United States
(12) Patent Application Publication
(10) Pub. No.: US 2024/0319392 A1
(43) Pub. Date: Sep. 26, 2024

(54) FULL WAVEFORM LOCATION TECHNOLOGY AND METHOD TO DETECT AND LOCATE MICROSEISMIC EVENTS AND CHARACTERISE THEIR MOMENT TENSOR

(71) Applicant: Tenzor Geo LTD, Aberdeen (GB)

(72) Inventors: Vasiliy Ryzhov, Kazan (RU); Sergey Feofilov, Kazan (RU); Ilshat Sharapov, Kazan (RU); Roy Bitrus, Aberdeen (GB); Ildar Gadeev, Kazan (RU)

(21) Appl. No.: 18/410,725

(22) Filed: Jan. 11, 2024

Related U.S. Application Data
(60) Provisional application No. 63/491,543, filed on Mar. 22, 2023.

(51) Int. Cl. G01V 1/28

(52) U.S. Cl. CPC G01V 1/288; G01V 2210/123; G01V 2210/324

(57) ABSTRACT

System and methods used to localize microseismic events and determine the seismic moment tensor of microseismic events created by geological processes such as rock fracturing, rock slippage, fluid migration within rock pore spaces and man-made events such as hydraulic fracturing and reservoir stimulation. The recorded response from a microseismic event is usually contaminated with strongly correlated noise and to determine the most probable location of the source a unique processing method the maximum likelihood estimation (MLE) is applied.

### RELATED APPLICATION

This application claims priority to U.S. Provisional Application No. 63/491,543, filed Mar. 22, 2023, which is incorporated herein in its entirety.

### TECHNICAL FIELD

This invention relates to systems and methods used to locate microseismic events by determining their seismic moment tensor in the presence of strongly correlated noise.

### BACKGROUND

Microseismic monitoring allows for continuous assessment of the medium state and for control over physical processes generating elastic waves, in particular the process of hydraulic fracturing, commonly known as fracking, where a well is drilled into the rock formation and a mixture of water, sand, and chemicals is injected under high pressure to crack or fracture the rock and release the trapped hydrocarbons.

There is a need for improved systems and methods for accurately identifying and filtering out correlated noise.

### SUMMARY

The invention allows for estimation of the parameters of seismic events that are covered by correlated noises. This invention allows the use of all possible information from the sources and their wave packets, as seismic moment magnitude and seismic moment tensor are estimated for all detected events.

In an embodiment, a method for detecting and locating microseismic events comprises positioning a plurality of sensors for recording microseismic signals in a predetermined observation area comprising a study volume with a plurality of study points. The method further comprises modeling seismic-mechanical properties for the predetermined observation area based on prior data, wherein the prior data comprises a vertical seismic profile, maps of active seismic depth, or time. Expected microseismic responses on sensors from the study points of the study volume are simulated. Quasi-harmonic interference in the collection of recorded microseismic signals is filtered by channel. Model responses are calibrated using inverse filters. The location of a microseismic event is predicted by a seismic moment tensor. This seismic moment tensor is determined at each grid point of the study volume using the maximum likelihood method to determine the type of event. A moment magnitude of the event is calculated to further define the event.

In an embodiment, the event comprises isotropic (ISO), tensile crack (TC), shear source (DC), linear dipole (DIP) or compensated linear dipole (CLVD).

In an embodiment, the plurality of sensors comprises a patch with a predetermined step between each of the plurality of sensors in the patch. In an embodiment, some of the plurality of sensors are excluded from the patch due to a significant deviation of the statistical attributes of the sensor record relative to the distribution of attributes of other sensor records. In an embodiment, the installation point of a single sensor or a patch of sensors comprises an observation point and a plurality of observation points comprises a network. In an embodiment, the observation points are uniformly distributed throughout the observation area.

In an embodiment, one or more patches are calibrated and after the calibration procedure has been applied to the one or more patches, one or more of the plurality of sensors are reinstalled from uncalibrated patches to calibrated patches.

In an embodiment, a system for detecting and locating microseismic events comprises a plurality of sensors positioned for recording microseismic signals with a plurality of channels in a predetermined observation area comprising a study volume with a plurality of study points. The system further comprises a computing device with a processor, memory, and nonvolatile storage, configured for modeling seismic-mechanical properties for the predetermined observation area based on prior data, wherein the prior data comprises a vertical seismic profile, maps of active seismic depth, or time.

A number of modules are configured for tasks under computing-device control. A simulation module is configured for simulating expected microseismic responses on sensors from the study points of the study volume. A filtering module is configured for filtering quasi-harmonic interference in the collection of recorded microseismic signals by channel. A calibration module is configured for calibrating model responses using inverse filters. A seismic-event location module is configured for predicting the location of a microseismic event and for determining a seismic moment tensor at each grid point of the study volume using the maximum likelihood method to determine the type of event. The seismic-event location module is also configured for calculating a moment magnitude of the event.

In some embodiments, the plurality of sensors comprises a patch with a predetermined operation between each of the plurality of sensors in the patch and some of the plurality of sensors are excluded from the patch due to a significant deviation of the statistical attributes of the sensor record relative to the distribution of attributes of other sensor records. In an embodiment, the installation point of a single sensor or a patch of sensors comprises an observation point. In an embodiment, the observation points comprise a network and the observation points are uniformly distributed throughout the observation area. In an embodiment of the system, one or more patches are calibrated and after the calibration procedure has been applied to the one or more patches, one or more of the plurality of sensors are reinstalled from uncalibrated patches to calibrated patches.

An alternative method for detecting and locating microseismic events comprises modeling seismic-mechanical properties for a predetermined area comprising a study volume with a plurality of study points. The modeling is based on prior data and wherein the prior data comprises a vertical seismic profile, maps of active seismic depth, or time. Expected microseismic responses from sensors located at the study points of the study volume are simulated. A collection of recorded microseismic signals from the predetermined area is received and quasi-harmonic interference in the collection of recorded microseismic signals is filtered by channel. Model responses are calculated using inverse filters and the location of a microseismic event is predicted.

A seismic moment tensor is determined at each grid point of the study volume using the maximum likelihood method to determine the type of event and a moment magnitude of the event is calculated.

In an embodiment, the collected, recorded microseismic signals were registered by a plurality of sensors comprising a patch with a predetermined operation between each of the plurality of sensors in the patch. In an embodiment, some of the plurality of sensors were excluded from the patch due to a significant deviation of the statistical attributes of the sensor record relative to the distribution of attributes of other sensor records. In an embodiment, one or more patches were calibrated and after the calibration procedure was applied to the one or more patches, one or more of the plurality of sensors were reinstalled from uncalibrated patches to calibrated patches. In an alternative embodiment, the determined event type is represented in 3D space in the form of beachballs.

### BRIEF DESCRIPTIONS OF THE DRAWINGS

FIG. 1 is a flowchart showing operations of a Full-Waveform Location (FWL) system, according to an embodiment.

FIG. 2 is a high-level flowchart for implementing FWL systems, according to an embodiment.

FIG. 3 is a simplified diagram of acquisition design, according to an embodiment.

FIG. 4 is a schematic of a model created in accordance with an embodiment.

FIG. 5 is a series of force diagrams showing x, y, and z components used for simulation, according to an embodiment.

FIG. 6 are graphs of results of a simulation, according to an embodiment.

FIG. 7 is a diagram illustrating an applied cascade of seismographic signal filters, according to an embodiment.

FIG. 8 shows an exemplary 3D diagram representing a seismic event detected, according to an embodiment.

### DETAILED DESCRIPTION OF THE DRAWINGS

Systems and methods can be applied on microseismic data acquired from surface sensors, downhole (well) sensors, and a mixture of both surface and downhole data, simultaneously acquired. The invention can be applied in the oil and gas industry, more specifically in microseismic monitoring and can be applied to monitor hydraulic fracking, water injection, CO2 injection, and any downhole (well) stimulation or intervention that will generate microseismic emissions.

The source mechanism of any microseismic event can be characterized by the seismic moment tensor. The seismic moment tensor depends on the intensity of the source and the displacement and orientation of the medium, within the vicinity of the seismic source. Locating an asynchronous seismic event and characteristics of its moment tensor by waves observed at several points (seismometers) in the presence of high correlated noise is a complex inverse problem.

Passive microseismic monitoring consists of a continuous recording of microseismic noise by permanently installed seismological sensors in order to localize sources of underground microseism of natural and man-made character.

By comparing the actual form of microseismic signals with simulated signals with various types of sources the mechanism of the seismic moment tensor is estimated. This comparison is accomplished by full-wave numerical simulation.

The result of the comparison of the modeled and observed seismic waveforms or signals is a set of events for the studied depth interval. The result can also include an estimate of the coordinates of their spatial localization, event type: Isotropic (ISO), Tensile crack (TC), Shear Source (DC), Linear Dipole (DIP), Compensated linear dipole (CLVD)), amplitude, and most likely azimuth.

In general, the location of microseismic pulses with the definition of their parameters can be used to solve a number of technological and geological problems.

Natural active fracturing can be monitored with the determination of the dominant horizontal stress directions of natural active fracturing, including monitoring of hydraulic fracturing (HF) and monitoring of the development of hydrocarbon deposits (injection of liquid or steam, assessment of drainage zones, intra-layer combustion, etc.). In the process of installing the recording systems, the environment is not harmed.

Due to the use of full-wave 3D numerical simulation, the location uses full information about the signal at the sensor installation sites for the three components (full-wave response, including compression, shear, exchange, and refraction) from single impulse impact in the reservoir, which allows working in geological environments of any complexity.

The seismic moment tensor is estimated for each seismic event, which allows for determining each event type (volume, shear, etc.) and the azimuth of the crack that formed it. Localization of events is performed using the maximum likelihood estimation (MLE) method, which optimizes localization of the event with a low signal-to-noise ratio.

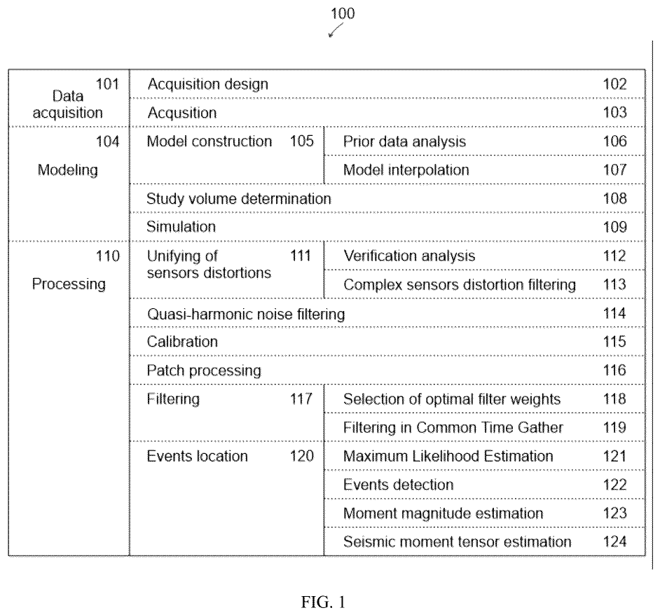

Aspects and embodiments of the invention are shown in FIGS. 1-8.

FIG. 1 is a flowchart showing operations 100 of the Full-Waveform Location (FWL) system from through the stages of data acquisition 101, modeling 104, and processing stage 110. Other aspects of FIG. 1 will be discussed in detail below.

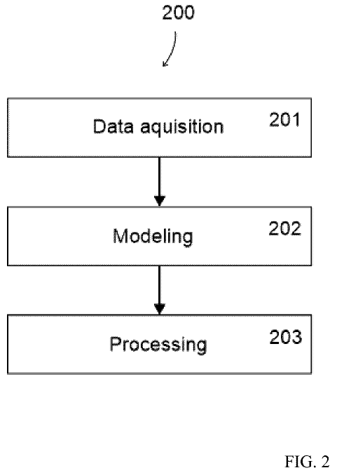

FIG. 2 is high-level flowchart of method 200, showing the operations of data acquisition 201, modelling 202 and processing 203.

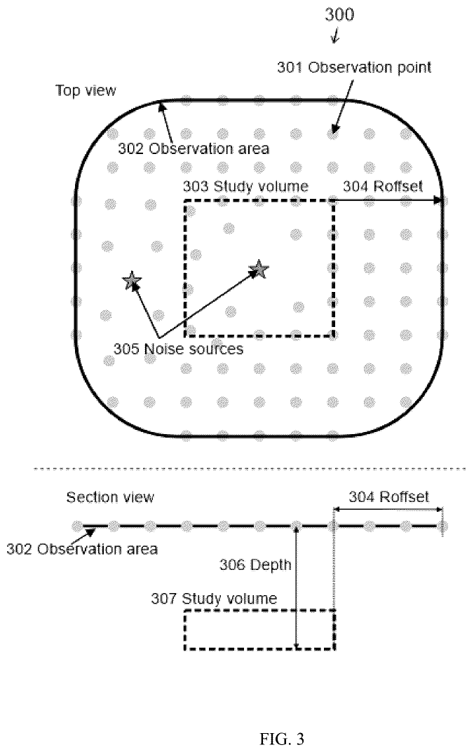

FIG. 3 is a simplified diagram of acquisition design 300, which corresponds to acquisition design 102 in FIG. 1. Observation points 301 are positioned in the observation area 302 over the study volume 303. Roffset 304 refers to the offset of observation area 302 from study volume 303. Observation points 301 are by design positioned far from noise sources 305. Depth 306 is the minimal distance from observation area 302 to the outer boundary of study volume 303.

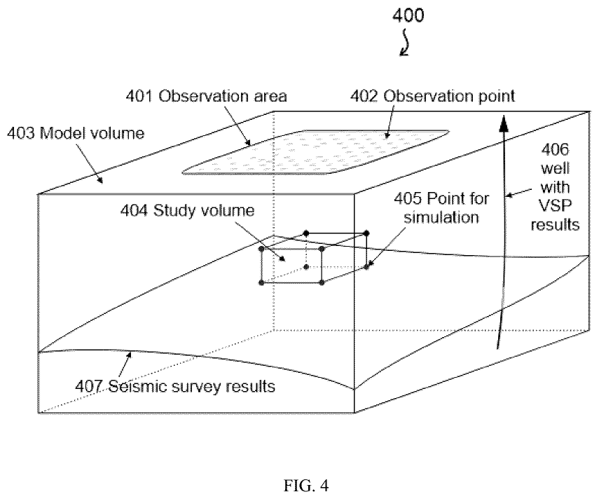

FIG. 4 shows a schematic 400 of a model. Simulated responses from observation area 401 are recorded at observation points 402. Model volume 403 is created on the basis of prior information. For simulation of study volume 404, forces are applied to several points for simulation 405. In an embodiment, the prior information used to create model volume 403 comprises VSP results 406 and seismic survey results 407.

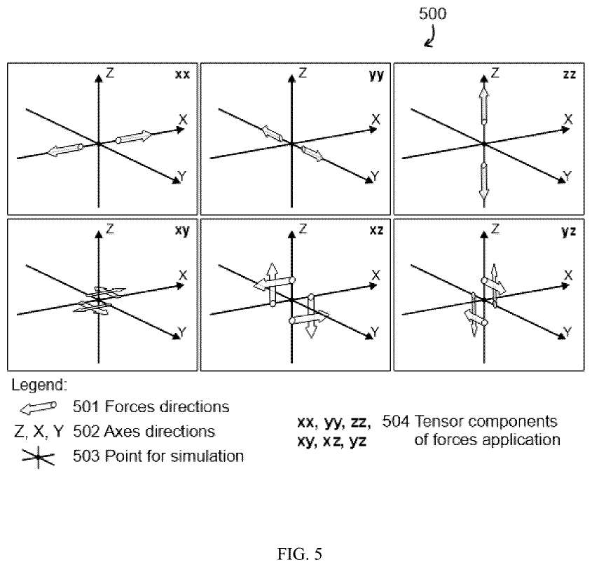

FIG. 5 is a series of force diagrams 500 showing x, y, and z components. Forces 501 are applied in axes directions 502 around the point for simulation 503 by the seismic moment tensor components 504.

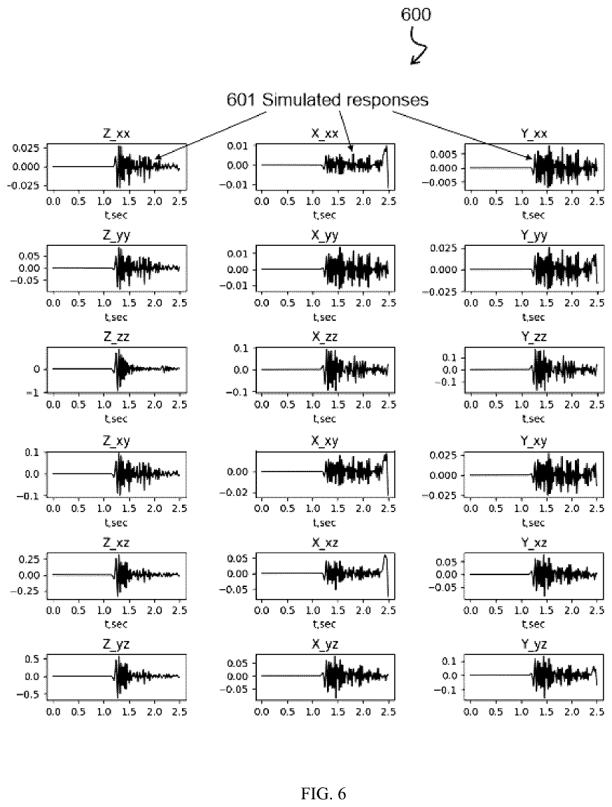

FIG. 6 shows results 600 of simulation. For one point of simulation 405 (FIG. 4), 503 (FIG. 5) for one observation point 301 (FIG. 3), 402 (FIG. 4) is a batch of 18 simulated responses 601. The three components of recordings at observation point 301 (FIG. 3), 402 (FIG. 4) for six ways of force application 504 (FIG. 5).

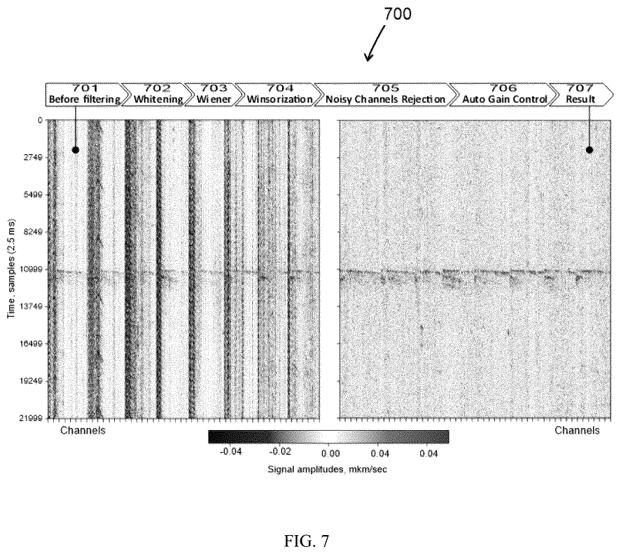

FIG. 7 shows an embodiment 700 of applying the cascade of filters. Seismograms before filtering 701 are shown first. Filters then follow, comprising Whitening 702, Wiener filtering 703, Winsorization 704, Noisy Channels Rejection 705, and Auto Gain Control 706. After filtering comes Result 707.

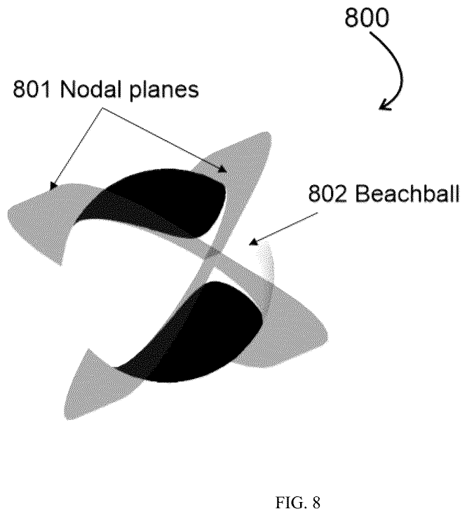

FIG. 8 shows an example 800 of the representation of the seismic event using Beachball 802 with two overcrossed Nodal planes 801.

An exemplary embodiment of the invention will be described with references to FIGS. 1-8. Data-acquisition operation 101, referring here to passive seismic data acquisition, obtains information about subsurface geological structures, properties, and processes without the use of active sources such as explosions. This is typically achieved by deploying seismometer sensors, which can detect and measure small vibrations in the ground.

Acquisition design 102 comprises several operations. Study volume 303 is determined by the conditions and characteristics of the problem being solved. The observation arca 302 extends beyond the projection of study volume 303 onto the observation plane on Roffset 304 which must be more than 0.5*depth 306 and less than Depth 306, where Depth 306 is the minimal distance from the observation area 302 to the far boundary of study volume 303, 307 (FIG. 3).

In an embodiment, sensors are combined into patches with a predetermined operation between sensors that optimizes surface-wave suppression.

There are several benefits from using patches. A patch allows for calibration to a weak level.

Using patches, the synchronization of records and exclusion or fitting out-of-sync sensors to the general group of synchronized records can be controlled. Weighted summation between sensors of a patch is applied after excluding low quality sensors. Beamformed weighted summation between sensors of patch can be applied. The number of sensors in a patch can be different in the area of observation 302. The number of sensors in a patch is calculated based on the estimated signal and noise level at the location of the sensor or patch of sensors

In an embodiment, estimation of the optimal operation for the surface wave suppression takes place during the acquisition stage. For example, sensors can be installed in wells. Observation point 301 comprises the place of installation of a single sensor or patch of sensors or the place of installation of a sensor in a well. The network of observation points 301 is predominantly uniform throughout observation area 302. The position of observation points 301 shifts away from man-made and natural noise sources 305. These sources can be identified based on satellite images, situational plans, and reconnaissance. Examples of natural noise sources include trunks and roots of trees, bushes, ravines, rivers, and so on.

Observation points 301 are designed in places in contact with the ground surface, ideally with a dense, solid soil and not a swamp or loose soil. Observation points 301 can be shifted depending on the calibration results 115. Sensors are removed from observation points 301 that have not been calibrated and installed in the calibrated observation points 301. The number of sensors at observation points can be redistributed depending on the signal-to-noise (SNR) ratio based on the calibration results 115.

Acquisition operation 103 refers to acquisition of microseismic signals at the location of the sensors. Sensors can be cabled, single nodes, downhole tools, fibre optic and other seismic or acoustic tools. Different instruments can be used that record seismic signals, including (wired/wireless, 1-component, 3-component, velocimeters, accelerometers, distributed acoustic sensing (DAS), and so on. In the event that different types of equipment are used, the sensor equipment is subject to quality control. Quality control is accomplished by a synchronous registration in one place and can be performed by all types of sensors using two or more sensors of each type of sensor. These records build inverse filters for complex sensor distortion filtering that brings records of different types of sensors in terms of frequency characteristics to the basic type of sensor.

Acquisition 103 includes registration of the calibration impact. In an embodiment, registration by sensors is carried out during the period of the process under study. For example, the process under study can be hydraulic fracturing, flooding, or other impact causing seismicity. Alternatively, background registration is performed that is not related to external impact.

Modeling operation 104 comprise model construction 105. This construction refers to a model built based on the available prior data 106. In an embodiment, the prior data comprises prior data on the velocity law, such as VSP results 406. Prior data can also be based on the two-way-time (TWT) maps by seismic survey results 407, or other available data. The properties of mechanical volume are calculated based on the velocity data (such as VSP) by model interpolation 107 through the seismic depths map in view of the TWT maps.

Study volume determination 108 will be explained with reference to FIG. 4. The study volume 404 geometry sizes depend on the necessary space where the problem is solved. The large size of study volume 404 leads to an expanse of computer time when simulating and when events are located by MLE method. Points for simulation are distributed by grid across the study volume 404. Simulation 405 is performed only on a sparse grid of points, followed by the synthesis of responses for intermediate points within study volume 404. Distance between sparse points 405 for simulation depends on frequency content of responses, determined theoretically and also empirically by quality control (QC) of the synthesis results.

Simulation 109 can be performed using a Ray-tracer of varying complexity and by using grid numerical methods with different physical approximation accuracy from acoustic approximation to more complex viscoelastic, multiphase, anisotropic, and other models.

Forces 501 are applied in Axes directions 502 by the seismic moment tensor components 504 around the point for simulation 503.

Simulated responses 601 refer to responses on applied forces. These responses are recorded in observation points 402, the places of the model corresponding to the actual position of the sensors, by Z, X, Y components of the record.

In an embodiment, simulated responses for the dense grid of study volume 402 are synthesized on the base of responses simulated on the sparse grid.

Processing operation 110, including the unification of sensor distortion 111 is carried out by a processing module. This operation includes the unification of sensor distortion 111 to correct the sensor's characteristics. The unification of sensors distortion 111 performs the verification analysis 112 and complex sensors distortions filtering 113. When different types of recording equipment are used, the frequency characteristics of the types of equipment are adjusted to the basic type of equipment. This is done by the verification record produced by verification analysis 106 and the implementation of inverse filters calculated by complex sensor distortions filtering 107 and their application. Complex sensor distortion filtering 113 is performed on the basis of inverse filters that are calculated at verification analysis operation 112 and can be retrieved from the simultaneous records made in one point. Alternatively, inverse filters are synthesized from manufacturer sensor descriptions.

Quasi-harmonic noise filtering 114 subtracts harmonic components of a recording while preserving the background broadband components of the recording. When conducting microseismic studies, a developed noise component is quasi-harmonic noise from technical objects with rotating parts such as pumps, rocking chairs, drilling tools, and so on. To remove this noise, an adaptive procedure for subtracting the harmonic component of the signal (filtering of quasi-harmonic noise 114) is used. Unlike notch filters, quasi-harmonic noise filtering preserves the background component of the recording. A useful signal in solving the problem of locating microseismic events is a broadband response with a short duration of less than 1 second. The criterion separating the useful signal from the harmonic noise is that the minimum size of the moving filtering window is much larger than the useful signal duration, which guarantees very low suppression of the useful signal. The Quasi Harmonic Noise Filter is a tool that subtracts the harmonic noise component from the signal, while saving the useful broadband background signal.

Calibration 115 of the locating system has several distinct aspects. The characteristics of the calibration charge are calculated based on physical laws of wave propagation and empirically fitted coefficients based on relevant data. This data includes average noise level, distance of sensors to the calibration site, number of sensors in a patch, number of calibration explosions, and so on. Calibration is used to take into account the discrepancy between simulated waveforms and those recorded in reality. The result of the calibration for each channel are inverse filters that bring the simulated waveforms to the shape of the real calibration pulse. Calibration is performed on wave packets that reveals both the real response from the calibration effect and in the simulated response.

Patch processing 116 refers to processing of records from sensors within each patch. Some signals from sensors in a patch of sensors are excluded from the averaging of the patch due to a significant deviation of the statistical attributes of the record relative to the distribution of the attributes of the main group of sensor records.

Filtering 117 comprises selection of optimal filter weights 118, which can be performed by conducting a special experiment with mixing a sample of real noise and responses of model events. The optimization criterion may be the composite and may include maximum recall at a fixed precision and the minimum error in the location of events in space and time.

A number of filters can be applied in the common time gather operation 119. Examples of these filters are shown in FIG. 7. One filter is whitening 702 with weight correction. Whitening 702 with weight correction is an alignment of the amplitudes of the spectral composition of the records. Wiener filter 703 with weight adjustment aligns the amplitude spectrum of a real record to the shape of the amplitude spectrum of the search signal. Winsorization 704 with adjustable rolling window length equalizes the standard deviation of the recording in the rolling window. Rejection of channels by noise level 705 with parameter setting and Auto Gain Control 706 equalizes the noise level on the channels with weight adjustment.

Events location 120 will now be described. For each dense grid point of the study volume 404, seismic moment coefficients of the simulated responses are estimated by MLE method 121. The decision function (SNRloc) is built on the basis of an estimate of the lower bound of the variance of the estimated coefficients and is expressed from the Rao-Kramer inequality and the Fisher information matrix. The event is detected at operation 122 at the global maximum of the decision function in some space and time of the SNRloc of Study volume 404. The event detection threshold is chosen based on the analysis of the results of the synthesized noise location by the allowable number of false events per time interval. The moment magnitude 123 of the event is calculated based on the estimated seismic moments components at the simulated responses.

The type of events 802 and their orientation are calculated on the basis of estimated seismic moment tensor 124. Detected seismic events are represented in 3D space in the form of Beachballs 802 or complemented by other objects, such as nodal planes 801.

1. A method for detecting and locating microseismic events, comprising:
positioning a plurality of sensors for recording microseismic signals in a predetermined observation area comprising a study volume with a plurality of study points;
modeling seismic-mechanical properties for the predetermined observation area based on prior data, wherein the prior data comprises a vertical seismic profile, maps of active seismic depth, or time;
simulating expected microseismic responses on sensors from the study points of the study volume;
filtering of quasi-harmonic interference in the collection of recorded microseismic signals by channel;
calibrating model responses using inverse filters;
predicting a location of a microseismic event;
determining a seismic moment tensor at each grid point of the study volume using a maximum likelihood method to determine a type of event; and
calculating a moment magnitude of the event.

2. The method of claim 1, wherein the event comprises isotropic (ISO), tensile crack (TC), shear source (DC), linear dipole (DIP) or compensated linear dipole (CLVD).

3. The method of claim 1, wherein the plurality of sensors comprises a patch with a predetermined operation between each of the plurality of sensors in the patch.

4. The method of claim 2, wherein some of the plurality of sensors are excluded from the patch due to a significant deviation of the statistical attributes of the sensor record relative to the distribution of attributes of other sensor records.

5. The method of claim 2, wherein an installation point of a single sensor or a patch of sensors comprises an observation point.

6. The method of claim 4, wherein a plurality of observation points comprises a network and the observation points are uniformly distributed throughout the observation area.

7. The method of claim 2, wherein one or more patches are calibrated and after the calibration procedure has been applied to the one or more patches, one or more of the plurality of sensors are reinstalled from uncalibrated patches to calibrated patches.

8. A system for detecting and locating microseismic events, comprising:
a plurality of sensors positioned for recording microseismic signals with a plurality of channels in a predetermined observation area comprising a study volume with a plurality of study points;
a computing device with a processor, memory, and nonvolatile storage, configured for modeling seismic-mechanical properties for the predetermined observation area based on prior data, wherein the prior data comprises a vertical seismic profile, maps of active seismic depth, or time;
a simulation module, under computing-device control, configured for simulating expected microseismic responses on sensors from the study points of the study volume;
a filtering module, under computing-device control, configured for filtering quasi-harmonic interference in the collection of recorded microseismic signals by channel;
a calibration module, under computing device control, configured for calibrating model responses using inverse filters;
a seismic-event location module, under computing device control, configured for predicting a location of a microseismic event,
wherein the seismic-event location module is further configured for determining a seismic moment tensor at each grid point of the study volume using a maximum likelihood method to determine a type of event; and
wherein the seismic-event location module is further configured for calculating a moment magnitude of the event.

9. The system of claim 8, wherein the event comprises isotropic (ISO), tensile crack (TC), shear source (DC), linear dipole (DIP) or compensated linear dipole (CLVD).

10. The system of claim 8, wherein the plurality of sensors comprises a patch with a predetermined operation between each of the plurality of sensors in the patch.

11. The system of claim 10, wherein some of the plurality of sensors are excluded from the patch due to a significant deviation of the statistical attributes of the sensor record relative to the distribution of attributes of other sensor records.

12. The system of claim 10, wherein an installation point of a single sensor or a patch of sensors comprises an observation point.

13. The system of claim 12, wherein a plurality of observation points comprises a network and the observation points are uniformly distributed throughout the observation area.

14. The system of claim 10, wherein one or more patches are calibrated and after the calibration procedure has been applied to the one or more patches, one or more of the plurality of sensors are reinstalled from uncalibrated patches to calibrated patches.

15. A method for detecting and locating microseismic events, comprising:
modeling seismic-mechanical properties for a predetermined area comprising a study volume with a plurality of study points, wherein the modeling is based on prior data and wherein the prior data comprises a vertical seismic profile, maps of active seismic depth, or time;
simulating expected microseismic responses from sensors located at the study points of the study volume;
receiving a collection of recorded microseismic signals from the predetermined area;
filtering quasi-harmonic interference in the collection of recorded microseismic signals by channel;
calibrating model responses using inverse filters;
predicting a location of a microseismic event;
determining a seismic moment tensor at each grid point of the study volume using a maximum likelihood method to determine a type of event; and
calculating a moment magnitude of the event.

16. The method of claim 15, wherein the event comprises isotropic (ISO), tensile crack (TC), shear source (DC), linear dipole (DIP) or compensated linear dipole (CLVD).

17. The method of claim 15, wherein the collection of recorded microseismic signals was registered by a plurality of sensors comprising a patch with a predetermined operation between each of the plurality of sensors in the patch.

18. The method of claim 17, wherein some of the plurality of sensors were excluded from the patch due to a significant deviation of the statistical attributes of the sensor record relative to the distribution of attributes of other sensor records.

19. The method of claim 17, wherein one or more patches were calibrated and after the calibration procedure was applied to the one or more patches, one or more of the plurality of sensors were reinstalled from uncalibrated patches to calibrated patches.

20. The method of claim 15, wherein the determined type of event is represented in 3D space in the form of beachballs.
